(19) United States
(12) Patent Application Publication
(10) Pub. No.: US 2025/0177866 A1
(43) Pub. Date: Jun. 5, 2025

(54) METHOD FOR DETERMINING DAMAGE RANGE OF SKILL, AND ELECTRONIC DEVICE, AND STORAGE MEDIUM THEREOF

(71) Applicant: NETEASE (HANGZHOU) NETWORK CO., LTD., Hangzhou, Zhejiang (CN)

(72) Inventors: Rui LIU, Hangzhou, Zhejiang (CN); Jianwei YIN, Hangzhou, Zhejiang (CN)

(73) Assignee: NETEASE (HANGZHOU) NETWORK CO., LTD., Hangzhou, Zhejiang (CN)

(21) Appl. No.: 18/836,788

(22) PCT Filed: Feb. 10, 2023
(86) PCT No.: PCT/CN2023/075488

§ 371 Date: Aug. 8, 2024

(30) Foreign Application Priority Data
Mar. 2, 2022 (CN) 202210197590.6

(51) Int. Cl. A63F 13/58

(52) U.S. Cl. CPC A63F 13/58

(57) ABSTRACT

A method for determining a damage range of a skill, an electronic device, and a storage medium are provided. The method includes: in response to release of a target skill, determining a release position of the target skill, wherein the release position is located in a scene unit within a virtual scene including a plurality of scene units arranged consecutively, and the scene unit is hexagonal; acquiring, based on the release position, a first relative position that includes position information of a damage range of the target skill relative to the release position; and determining the damage range of the target skill based on the first relative position.

### CROSS-REFERENCE TO RELATED APPLICATIONS

The present disclosure is a U.S. national phase application of International Application No. PCT/CN2023/075488, filed on Feb. 10, 2023, which is based on and claims priority to Chinese Patent Application No. 202210197590.6, filed on Mar. 2, 2022, titled “SKILL DAMAGE RANGE DETERMINING METHOD AND APPARATUS, AND ELECTRONIC DEVICE”, the entire contents of both of which are incorporated herein by reference in their entirety for all purposes.

### TECHNICAL FIELD

The present disclosure relates to the field of game technology and, in particular, to a method for determining a damage range of a skill, an electronic device, and a computer-readable storage medium.

### BACKGROUND

In combat games, a scene map of a game scene is typically composed of consecutive polygons, such as quadrilaterals or hexagons. Compared to quadrilateral scene maps, hexagonal scene maps have several advantages, such as the maximum area for the same perimeter, equal distances from the center of a cell to centers of adjacent cells in all directions, and deeper strategic potential. Since a damage range of a game skill is usually in standard shapes such as circles, rectangles, sectors, cones, etc., when calculating the damage range of the skill based on a hexagonal scene map, it is necessary to calculate whether each hexagon is within the damage range based on the shape of the damage range of the skill and the distribution of surrounding hexagons, which imposes significant computational burden.

It should be noted that the above information disclosed in the “BACKGROUND” section is provided solely to enhance understanding of the background of the present disclosure and may include information that does not constitute prior art known to those of ordinary skill in the art.

### SUMMARY

In view of the above, the purpose of the present disclosure is to provide a method for determining a damage range of a skill, an apparatus for determining a damage range of a skill, an electronic device, and a storage medium to reduce the computational burden when determining the damage range.

According to a first aspect of the present disclosure, a method for determining a damage range of a skill is provided, including: in response to release of a target skill, determining a release position of the target skill, where the release position is located in a scene unit within a virtual scene, the scene unit is hexagonal, and the virtual scene is composed of a plurality of scene units arranged consecutively; acquiring, based on the release position, first relative position information of a damage range of the target skill, where the first relative position information includes position information of the damage range of the target skill relative to the release position; and determining the damage range of the target skill based on the first relative position information of the damage range of the target skill.

According to a second aspect of the present disclosure, an electronic device is provided, including: a processor and a memory, where the memory stores instructions executable by the processor that, when executed by the processor, cause the processor to perform the method for determining the damage range of the skill described above.

According to a third aspect of the present disclosure, a non-transitory computer-readable storage medium is provided, where the non-transitory computer-readable storage medium stores instructions which, when invoked and executed by a processor, cause the processor to perform the method for determining the damage range of the skill described above.

Other features and advantages of the present disclosure will be described in the following description, which may become apparent in part from the description, or may be learned by practicing the present disclosure. The purposes and other advantages of the present disclosure are achieved and obtained with structures specifically pointed out in the description, claims, and drawings.

To make the above purposes, features, and advantages of the present disclosure more apparent and understandable, preferred embodiments will be described in detail below, accompanied by the attached drawings.

### BRIEF DESCRIPTION OF THE DRAWINGS

To illustrate technical solutions in specific embodiments of the present disclosure or in the existing technology more clearly, a brief description to the drawings required for use in describing the specific embodiments or the existing technology will be provided below. It is obvious that the drawings in the following description show some of the embodiments of the present disclosure. For those skilled in the art, other drawings can also be obtained based on these drawings without creative effort.

FIG. 1 is a schematic diagram of a damage range in a hexagonal scene map provided according to an embodiment of the present disclosure.

FIG. 2 is a flowchart of a method for determining a damage range of a skill provided according to an embodiment of the present disclosure.

FIG. 3 is a schematic diagram of a hexagonal coordinate system and a release position of a target skill provided according to an embodiment of the present disclosure.

FIG. 4 is a schematic diagram of first relative position information of a damage range of a target skill provided according to an embodiment of the present disclosure.

FIG. 5 is a schematic diagram of shapes of a damage range of a skill provided according to an embodiment of the present disclosure.

FIG. 6 is a schematic diagram of target scene units and a line connecting an object position and a release position provided according to an embodiment of the present disclosure.

FIG. 7 is a schematic diagram of target scene units and a line connecting an object position and a release position provided according to another embodiment of the present disclosure.

FIG. 8 is a schematic diagram of target scene units and a line connecting an object position and a release position provided according to yet another embodiment of the present disclosure.

FIG. 9 is a structural schematic diagram of an apparatus for determining a damage range of a skill provided according to an embodiment of the present disclosure.

FIG. 10 is a structural schematic diagram of an electronic device provided according to an embodiment of the present disclosure.

### DETAILED DESCRIPTION

In order to make the purposes, technical solutions and advantages of the embodiments of the present disclosure clearer, the technical solutions of the present disclosure will be described clearly and completely in the following in conjunction with the accompanying drawings. It is obvious that the described embodiments are some of the embodiments of the present disclosure, not all embodiments. Based on the embodiments disclosed herein, all other embodiments obtained by those skilled in the art without creative effort are within the scope of protection of the present disclosure.

Currently, in virtual scenes of combat games and other virtual scenes, both quadrilaterals and hexagons can be used as scene units to assemble scene maps. The application of scene maps composed of regular hexagons in games is becoming increasingly widespread. Compared to regular quadrilateral maps, regular hexagonal maps have many advantages, such as the maximum area for the same perimeter (i.e., high efficiency), equal distances from the center of a unit cell to centers of adjacent unit cells in all directions (i.e., fairness), and deeper strategic potential. However, the use of the regular hexagonal maps also faces challenges. For example, when an attacker simultaneously damages multiple hexagonal units, accurately calculating which hexagons are affected or damaged becomes crucial. For most attackers, a damage range caused by a skill typically takes standard shapes such as circles, rectangles, sectors, or cones. When these standard shapes intersect with hexagons, accurately determining which hexagons are affected is important for both the attacker and the attacked party.

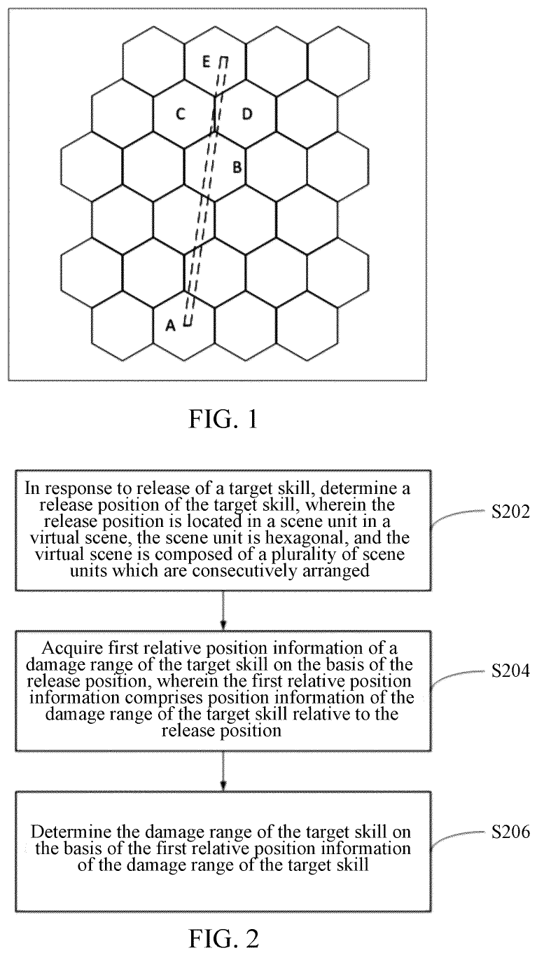

In related art, purely physical methods are used to calculate the damage range of the skill. For example, in some games, in addition to hexagons, there is also a conventional coordinate system, namely the Cartesian coordinate system. When calculating the damage range, intersections are calculated by using coordinates, a range, and a position of the attacked party in the Cartesian coordinate system. The main advantage of such an approach is that it is more intuitive and has strong visual appeal. However, it also brings significant disadvantages, and the disadvantages mainly include: the damage range is calculated by using the coordinates of the Cartesian coordinate system, which has no relation to the hexagons, and the strategic depth provided by the hexagons is not utilized; and the determination of the damage range can easily lead to confusion. Since standard shapes such as circles, rectangles, sectors, and cones may intersect with hexagons at any position when they are intersected by hexagons, it is very easy to cause ambiguity between the visual effect of whether or not a hexagon is affected and the actual result, which is confusing to the players. As shown in FIG. 1, if a virtual object in position A releases a skill in position B, causing damage to the enemies in position B and a straight line after it, whether the damage range involves damage to positions C, D and E is very easy to produce ambiguity, leading to confusion for the user, which affects the user's play of combat strategy. Additionally, during combat, frequent calculations to determine if each unit is within the damage range consume significant computational resources. For example, in a team battle where dozens of hexagons are filled with teams, each time an area-of-effect damage is generated in each unit, it is necessary to calculate whether each unit is within the range of the damage, which brings great computational pressure.

Based on the above, embodiments of the present disclosure provide a method for determining a damage range of a skill, an apparatus for determining a damage range of a skill, an electronic device, and a machine-readable storage medium. This technology can be applied in games, animations, and films, specifically for determining a damage range of a skill in games or other three-dimensional scenes.

For ease of understanding the embodiments, a detailed description of a method for determining a damage range of a skill disclosed herein is provided. As shown in FIG. 2, the method includes the following steps S202 to S206.

Step S202, in response to release of a target skill, determining a release position of the target skill, where the release position is located in a scene unit of a virtual scene, and the scene unit is a hexagon, and the virtual scene is composed of a plurality of scene units arranged consecutively.

For example, in combat games' scenes or other virtual scenes, a scene map of the virtual scene is typically composed of consecutively arranged polygons that are spliced together. The position of a virtual object in the scene can be represented by the position of the polygon where the virtual object is located. Each virtual object is equipped with at least one predefined skill, and information such as the damage shape, damage distance, and shooting range/effective range of each skill was set during the initial design. For instance, the skill “Summon Meteor” is set with a circular damage shape and a damage distance of 2, while the skill “Release Tornado” is set with a rectangular damage shape and a damage distance of 4, and so on. The damage shapes, distances, and shooting ranges/effective ranges for different skills can be completely different or partially similar. Based on this, after selecting a virtual object to be controlled, users can choose an appropriate position within a shooting range/effective range of a target skill, based on characteristics of each skill possessed by the virtual object and a distance from the virtual object to a target object to be attacked, to release the skill and achieve the goal of damaging the target object.

In one embodiment, the virtual scene is composed of a plurality of consecutively arranged hexagons that are spliced together, that is, the scene unit is a hexagon, and the virtual scene is composed of a plurality of scene units arranged consecutively. When an attackable object appears in the virtual scene, the user controls a virtual object to release a skill at a specific position on the scene map, i.e., the target skill is released, causing damage to the attackable object. For example, the extent of damage caused to the attackable object depends on the release position of the target skill. The closer the release position is to the target object to be attacked, the higher the damage inflicted on the target object.

In an optional embodiment, in the virtual scene composed of a plurality of hexagons arranged consecutively, a hexagonal coordinate system is established to describe the positions of objects in the virtual scene, as well as the release positions of the target skills. Specifically, using a scene unit in which a virtual object is located as the origin, coordinates of the coordinate system are extended in three directions of that scene unit. Based on the shooting range and release direction of the target skill, the release position of the target skill is determined. In this case, the shooting range of the target skill can be 1, 2, 3, or 4, etc., and the skill with different ranges has different release positions. For example, when the shooting range of the target skill is 1, positions up to I unit away from the scene unit where the virtual object is located can serve as release positions, totaling 6 positions. Based on the release direction, the final release position can be determined. Similarly, when the shooting range of the target skill is 2, positions up to 2 units away from the scene unit where the virtual object is located can serve as release positions, totaling 18 positions. Based on the release direction, the final release position can be determined from these 18 positions. When the shooting range of the target skill is 3, positions up to 3 units away from the scene unit where the virtual object is located can serve as release positions, totaling 36 positions. Based on the release direction, the final release position can be determined from these 36 positions.

Step S204, acquiring, based on the release position, first relative position information of a damage range of the target skill, where the first relative position information includes position information of the damage range of the target skill relative to the release position.

Furthermore, after determining the release position of the target skill, the first relative position information of the damage range of the target skill is acquired. The damage range of the target skill is related to factors such as the damage shape, the damage distance, etc. of the skill. The damage shape of the skill includes shapes such as circle, rectangle, sector, cone, etc. The damage distance of the skill can be 1, 2, 3, or 4, etc. The aforementioned first relative position information includes the position information of the damage range of the target skill relative to the release position.

Although different release positions result in different positions of the damage range of the target skill in the virtual scene, there is a certain regularity in the relative positions between the damage range of the target skill and the release position due to the relatively fixed parameters of the skill such as the damage shape and the damage distance. Based on this, in this embodiment, the position information of the damage range of the target skill relative to the release position, i.e., the first relative position information, can be pre-set and stored. During the battle in the game, after obtaining the release position, the first relative position information is retrieved. By performing simple vector calculations between the release position and the first relative position information, the damage range of the target skill can be determined.

In a specific embodiment, a skill typically has a release direction. Since there are different release directions, one release position may correspond to multiple pieces of first relative position information. Each piece of first relative position information also needs to be determined based on a release range.

Step S206, determining the damage range of the target skill based on the first relative position information of the damage range of the target skill.

Based on the above, after obtaining the first relative position information of the damage range of the target skill, the damage range of the target skill can be obtained by adding the coordinate information of the release position of the target skill and the first relative position information as vectors.

In practical implementation, in one method, the shooting range of the target skill is relatively small; the line connecting the object position of the virtual object that releases the target skill and the release position is perpendicular to any side of a hexagonal scene unit in the virtual scene, or the line connecting the object position and the release position passes through any corner of a hexagonal scene unit in the virtual scene; and a center line of the damage range of the skill coincides with the line connecting the object position and the release position of the target skill. In this method, the damage range of the target skill can be obtained by adding the coordinate information of the release position of the target skill to the first relative position information.

In another method, the shooting range of the target skill is relatively large; the line connecting the object position and the release position is not perpendicular to any side of a hexagonal scene unit in the virtual scene, or the line connecting the object position and the release position does not pass through any corner of a hexagonal scene unit in the virtual scene. In this method, after adding the coordinate information of the release position of the target skill to the first relative position information, the damage range of the target skill is adjusted according to predefined rules, ensuring that an angle, between the center line of the damage range of the target skill and the line connecting the object position and the release position, is minimized, thereby adjusting the damage range to align more closely with the edge or corner, which is more in line with the player's perception.

In the above method for determining the damage range of the skill, the release position of the target skill is determined in response to the release of the target skill, where the release position is located in a scene unit in the virtual scene, the scene unit is a hexagon, and the virtual scene is composed of a plurality of scene units arranged consecutively; the first relative position information of the damage range of the target skill is acquired based on the release position, where the first relative position information includes the position information of the damage range of the target skill relative to the release position; and based on the first relative position information of the damage range of the target skill, the damage range of the target skill is determined. Through this method, the relative position information of the damage range of the target skill relative to the release position can be pre-stored, and after the release position is determined during the battle in the game, the damage range of the target skill can be directly determined based on the relative position information, without the need to calculate whether each hexagon is within the damage range, reducing the computation and alleviating the computational pressure.

Furthermore, the pre-stored relative position information of the damage range of the target skill relative to the release position is determined based on the hexagonal scene map. Based on the pre-stored relative position information of the damage range of the target skill relative to the release position, the damage range of the target skill is determined during the battle in the game, which can be understood as the damage range of the target skill is also determined based on the hexagonal scene map. Therefore, the damage range of the target skill matches the hexagonal scene map more accurately. Compared to calculating the damage range based on a conventional two-dimensional map and displaying it on a hexagonal scene map, this method can also improve the accuracy of displaying the damage range.

The following embodiments provide specific implementation methods for acquiring the first relative position information.

Specifically, second relative position information of the release position relative to the object position of the virtual object that releases the target skill is determined; and the first relative position information of the damage range of the target skill corresponding to the second relative position information is acquired. Here, when the second relative position information is different, the first relative position information corresponding to the second relative position information is also different.

In combat games' scenes, each virtual object possesses skill attributes including shooting range, damage shape, damage distance, etc. Based on the attribute of the shooting range of the skill, the release position of the target skill can be obtained, and then the second relative position information of the release position, relative to the object position of the virtual object, can be determined. For example, when the shooting range of the target skill is 1, 6 scene units each is 1 unit away from the virtual object can serve as release positions. Since the skill's release is also directional in the game scene, these 6 scene units have different positions relative to the virtual object. Based on the release direction of the skill, the final release position can be further determined. After determining the release position of the target skill, since the object position of the virtual object has also been known, the second relative position information can be determined to acquire the first relative position information of the damage range of the target skill corresponding to the second relative position information. The first relative position information is used to determine the damage range of the target skill.

Specifically, the virtual object can release the target skill in any direction. When the release direction of the target skill is different, the release position is also different. Based on this, the second relative position information can also be used to indicate the release direction of the target skill. When the release direction is different, the relative position between the damage range and the release position is also different. For example, when the virtual object releases the target skill to the right, the release position is located on the right side of the virtual object and the damage range is also located on the right side of the release position; and when the virtual object releases the target skill to the left, the release position is located on the left side of the virtual object and the damage range is also located on the left side of the release position. Therefore, different second relative position information means different release directions, and when the release directions are different, the first relative position information corresponding to the second relative position information will be different.

The first relative position information is related to the damage shape and the damage distance of the target skill. In one embodiment, when the damage shape of the target skill is a rectangle and the damage distance is 1, there will be 4 scene units each is 1 unit away from the release position to form the first relative position information. When choosing a different release position, the aforementioned first relative position information will change, that is, when the second relative position information is different, the first relative position information corresponding to the second relative position information is different.

The following embodiments provide specific implementation methods for determining the second relative position information.

Specifically, a first hexagonal coordinate system is established with a scene unit corresponding to the object position as the origin; and coordinate information of the release position in the first hexagonal coordinate system is determined as the second relative position information. The second relative position information is used to indicate a release direction and a release distance of the release of the target skill by the virtual object.

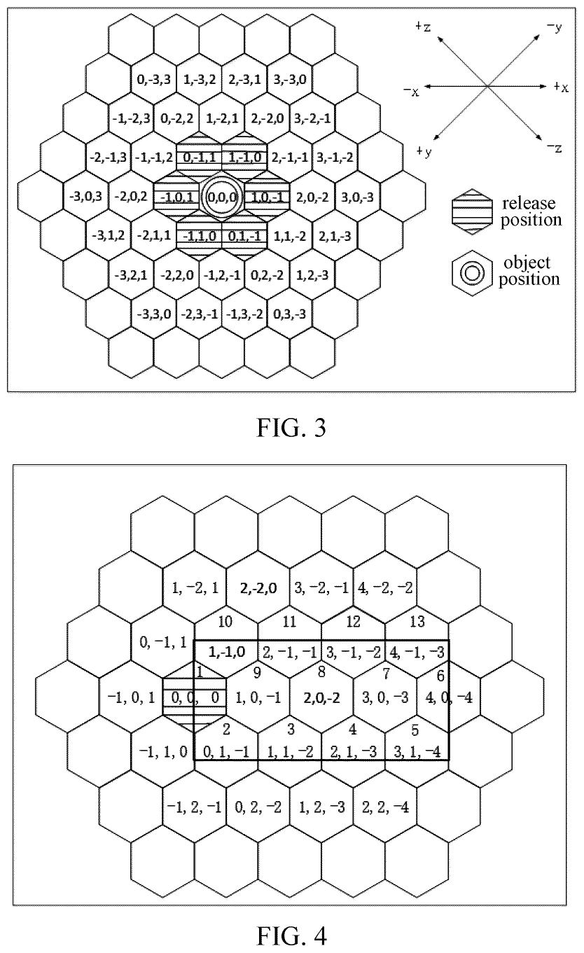

In a specific method, as shown in FIG. 3, by taking the scene unit where the virtual object is located as the coordinate origin, i.e., the object position is the coordinate origin, and extending the coordinates of the coordinate system in the three directions of the scene unit, the first hexagonal coordinate system is established. The coordinates of the object position of the virtual object is obtained as (0, 0, 0). The coordinate information of the release position in the hexagonal coordinate system is determined as the second relative position information. The release position of the skill depends on the shooting range of the skill, which is one of the attributes of the skill and is set when the skill is designed. The skill's shooting range can be 1, 2, 3, or 4. For instance, if the shooting range of the target skill is 1, the user can control the virtual object to release the target skill at a scene unit I unit away from the virtual object. Because there are three directions in this coordinate system, there are six choices for the release position, i.e., (1, −1, 0), (0, −1, 1), (−1, 0, 1), (−1, 1, 0), (0, 1, −1), (1, 0, −1). Referring to FIG. 3, if the release direction of the target skill is to the right, the coordinates of the release position are (1, 0, −1), which represent the second relative position information of the release position relative to the object position. This second relative position information can indicate the release direction and the release distance of the release of the target skill by the virtual object. Since the first hexagonal coordinate system mentioned above is established with the object position as the origin, the coordinates of the release position in this first hexagonal coordinate system can indicate the relative positional relationship between the release position and the object position. For example, when the release position is (−1, 0, 1), the release direction is to the left of the object position, and the release distance is 1. Similarly, when the release position is (−2, 0, 2), the release direction is to the left of the object position, and the release distance is 2.

After determining the second relative position information, the first relative position information of the damage range of the target skill corresponding to this second relative position information can be obtained by: establishing a second hexagonal coordinate system with a scene unit corresponding to the release position as the origin; setting one or more target scene units belonging to the damage range of the target skill; and determining coordinate information of the one or more target scene units in the second hexagonal coordinate system as the first relative position information of the damage range of the target skill corresponding to the second relative position information.

In one embodiment, by taking the scene unit where the release position is located as the coordinate origin, and extending the coordinates of the coordinate system in three directions of the scene unit, the second hexagonal coordinate system is established. The coordinates of the release position are determined as (0, 0, 0), and then one or more target scene units belonging to the damage range of the target skill are set. The damage range of the target skill is related to the factors such as the damage shape and the damage distance of the skill. The damage shape of a skill includes circle, rectangle, fan, cone, etc. The damage distance of a skill can be 1, 2, 3, or 4.

In an optional embodiment, as shown in FIG. 4, if a shooting range of the target skill is 1, a damage shape is rectangular, and a damage distance is 4, a total of 13 scene units can be affected or damaged when the user controls the virtual object in the first hexagonal coordinate system and selects (1, 0, −1) as a release position. In this case, a second hexagonal coordinate system is established with the release position as the origin to determine the coordinates of the 13 scene units, i.e., the first one is (0, 0, 0), the second one is (0, 1, −1), the third one is (1, 1, −2), the fourth one is (2, 1, −3), the fifth one is (3, 1, −4), the sixth one is (4, 0, −4), the seventh one is (3, 0, −3), the eighth one is (2, 0, −2), the ninth one is (1, 0, −1), the tenth one is (1, −1, 0), the eleventh one is (2, −1, −1), the twelfth one is (3, −1, −2), and the thirteenth one is (4, −1, −3). The above coordinate information of the 13 scene units, which can be referred to FIG. 4, is the first relative position information of the damage range of the target skill corresponding to the second relative position information.

The above embodiments of acquiring the first relative position information are related to the damage shape of the target skill. Specifically, the one or more target scene units belonging to the damage range of the target skill are set based on the shape of the damage range of the target skill. The damage shape of the skill is one of the attributes of the skill, including circle, rectangle, sector, cone and so on, which is set by the engineer when designing the skill. Since the damage shape is usually a standard shape that is difficult to match with the hexagon absolutely, to make the damage range as accurate as possible, it is necessary to set the target scene units based on the damage shape of the target skill. For example, the damage shape is a rectangle in FIG. 4, and the outline of the shape formed by multiple target scene units has a high degree of similarity with the rectangle. This method can improve the accuracy of the damage range, so that the damage range matches the damage shape of the skill and the player's perception.

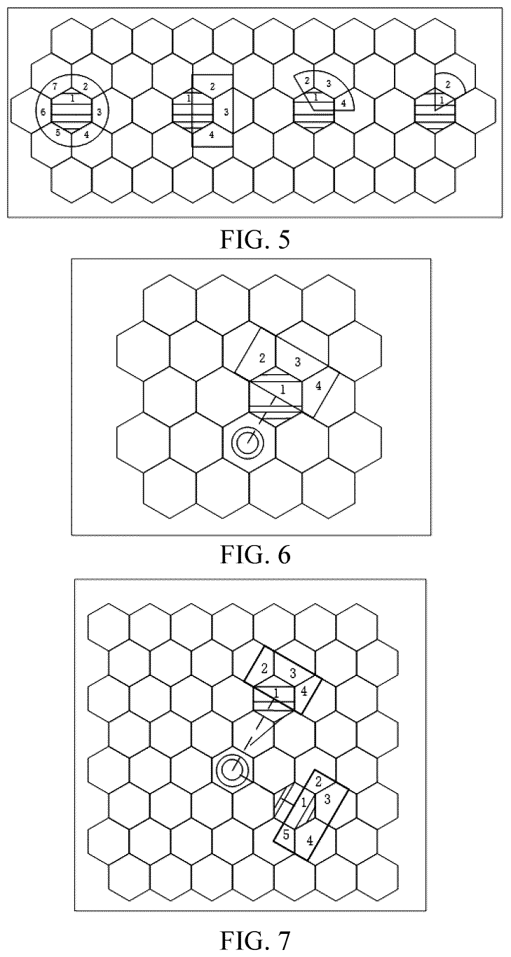

When a skill is released at the same position and at a fixed damage distance, a different shape of the damage range results in different damage coverage of the skill. For example, when the damage distance is 1, the damage shapes are circular, rectangular, sectorial, and conical, as shown in FIG. 5, and the damage coverage encompasses 7 scene units forming a circle, 4 scene units forming a rectangle, 4 scene units forming a sector, and 2 scene units forming a cone, respectively, with different sizes of the damage coverage.

The following embodiments provide a specific implementation method for setting the target scene units.

Specifically, if a line connecting the object position and the release position satisfies a specified condition, one or more target scene units are set to make a center line of an area corresponding to the one or more target scene units coincide with the line connecting the object position and the release position. If the line connecting the object position and the release position fails to satisfy the specified condition, one or more target scene units are set to minimize an angle between the center line of the area corresponding to the one or more target scene units and the line connecting the object position and the release position. The specified condition includes: the line connecting the object position and the release position being perpendicular to any side of a hexagonal scene unit in the virtual scene, or the line connecting the object position and the release position passing through any corner of a hexagonal scene unit in the virtual scene.

In one embodiment, for example, when a shooting range of the target skill is 1, as shown in FIG. 6, the line connecting the object position and the release position is perpendicular to any side of a hexagonal scene unit in the virtual scene. When a shooting range of the target skill is 2, as shown in FIG. 7, the line connecting the object position and the release position is perpendicular to any side of a hexagonal scene unit in the virtual scene, or the line connecting the object position and the release position passes through any corner of a hexagonal scene unit in the virtual scene. In this embodiment, the one or more target scene units are set so that the center line of the area corresponding to the target scene units coincides with the line connecting the object position and the release position.

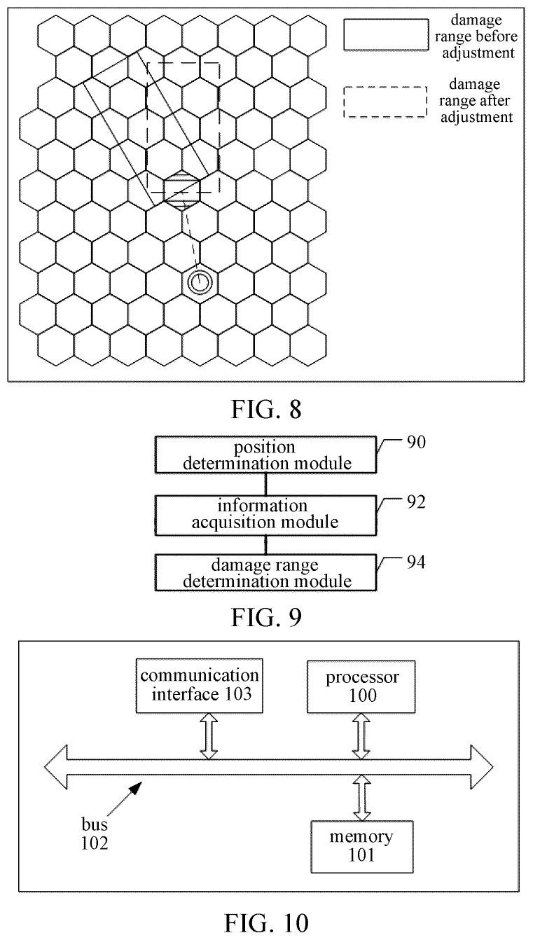

In another embodiment, when a shooting range of the target skill is 3, as shown in FIG. 8, the line connecting the object position and the release position is not perpendicular to any side of a hexagonal scene unit in the virtual scene, or the line connecting the object position and the release position does not pass through any corner of a hexagonal scene unit in the virtual scene. In this embodiment, the one or more target scene units are set so that the center line of the area corresponding to the one or more target scene units forms a minimum angle with the line connecting the object position and the release position.

Specifically, as shown in FIG. 8, when the above specified condition is not satisfied, i.e., when the line connecting the objection position and the release position is neither perpendicular to any edge of a hexagon nor passing through any corner of a hexagon, the resulting damage range obtained through the above embodiment is depicted by the solid rectangular box in FIG. 8. In this case, the damage range differs significantly from the skill's release direction, which does not match the player's perception. Therefore, adjustment of the damage range is necessary; such as adjusting it to the damage range depicted by the dashed box in FIG. 8. The goal of adjustment is to minimize the angle between the center line of the area corresponding to the target scene units and the line connecting the object position and the release position, thereby aligning the damage range as closely as possible with the skill's release direction to match the player's perception.

The following provides specific implementation methods for determining the damage range of the target skill.

Specifically, coordinate information of the release position in the first hexagonal coordinate system is acquired, where the first hexagonal coordinate system is a coordinate system with the scene unit corresponding to the object position as origin; and coordinate information of the damage range of the target skill in the first hexagonal coordinate system is determined based on the coordinate information of the release position in the first hexagonal coordinate system and the first relative position information of the damage range of the target skill.

In one embodiment, the first hexagonal coordinate system is established with the scene unit corresponding to the object position as the origin, the coordinate information of the release position in the first hexagonal coordinate system is determined, and then the coordinate information of the release position in the first hexagonal coordinate system is added to the first relative position information of the damage range of the target skill. In this way; the coordinate information of the damage range of the target skill in the first hexagonal coordinate system can be determined.

In an optional embodiment, when the damage shape of the target skill is rectangular and the damage distance is 4, taking (1, 0, −1) as the release position of the target skill, and using the above 13 scene units as an example of the first relative position information, the information of the damage range of the target skill in the first hexagonal coordinate system is as follows: Coordinate 1 is (1, 0, −1)+(0, 0, 0)=(1, 0, −1), Coordinate 2 is (1, 0, −1)+(0, 1, −1)=(1, 1, −2), Coordinate 3 is (1, 0, −1)+(1, 1, −2)=(2, 1, −3), Coordinate 4 is (1, 0, −1)+(2, 1, −3)=(3, 1, −4), Coordinate 5 is (1, 0, −1)+(3, 1, −4)=(4, 1, −5), Coordinate 6 is (1, 0, −1)+(4, 0, −4)=(5, 0, −5), Coordinate 7 is (1, 0, −1)+(3, 0, −3)=(4, 0, −4), Coordinate 8 is (1, 0, −1)+(2, 0, −2)=(3, 0, −3), Coordinate 9 is (1, 0, −1)+(1, 0, −1)=(2, 0, −2), Coordinate 10 is (1, 0, −1)+(1, −1, 0)=(2, −1, −1), Coordinate 11 is (1, 0, −1)+(2, −1, −1)=(3, −1, −2), Coordinate 12 is (1, 0, −1)+(3, −1, −2)=(4, −1, −3), and Coordinate 13 is (1, 0, −1)+(4, −1, −3)=(5, −1, −4). Based on this, the coordinate information of the damage range of the target skill in the first hexagonal coordinate system can be determined.

The method for determining the damage range of the skill provided in the above embodiments uses coordinates of ranges that pre-defined damage types with different shapes and different distances relative to a hexagonal coordinate system can damage, which significantly reduces computational pressure on one hand, and allows using the hexagon as the smallest unit to determine affected targets on the other hand, thus returning to the original intention of the game to use the hexagon as the base unit of the battle scene, i.e., maximizing the use of the strategic space brought by hexagons in combat. In addition, the embodiments of the present disclosure also correct the damage range in the non-edge and non-corner directions, which also makes the damage range generated by the actual battle more in line with the player's perception.

It should be noted that while the steps for determining the damage range of the skill in this disclosure are described in a specific order in the accompanying drawings, this does not require or imply that these steps must be executed in that specific order, or that all steps shown must be performed to achieve the desired result. Additionally, or alternatively, some steps may be omitted, multiple steps may be combined into a single step, and/or one step may be divided into multiple steps for execution.

For the method embodiments above, refer to an apparatus for determining a damage range of a skill as shown in FIG. 9, including a position determination module 90, an information acquisition module 92, and a damage range determination module 94.

The position determination module 90 is configured to, in response to release of a target skill, determine a release position of the target skill, where the release position is located in a scene unit within a virtual scene, the scene unit is hexagonal, and the virtual scene is composed of a plurality of scene units arranged consecutively.

The information acquisition module 92 is configured to acquire, based on the release position, first relative position information of a damage range of the target skill, where the first relative position information includes position information of the damage range of the target skill relative to the release position.

The damage range determination module 94 is configured to determine the damage range of the target skill based on the first relative position information of the damage range of the target skill.

According to the above apparatus for determining the damage range of the skill, the release position of the target skill is determined in response to the release of the target skill, where the release position is located at a scene unit in a virtual scene, the scene unit is hexagonal, and the virtual scene is composed of a plurality of scene units arranged consecutively; based on the release position, the first relative position information of the damage range of the target skill is acquired, where the first relative position information includes position information of the damage range of the target skill relative to the release position; and the damage range of the target skill is determined based on the first relative position information of the damage range of the target skill. Through this method, the relative position information of the damage range of the target skill relative to the release position can be pre-stored, and after the release position is determined during the battle in the game, the damage range of the target skill can be directly determined based on the relative position information, without the need to calculate whether each hexagon is within the damage range, reducing the computation and alleviating the computational pressure.

Furthermore, the pre-stored relative position information of the damage range of the target skill relative to the release position is determined based on the hexagonal scene map. Based on the pre-stored relative position information of the damage range of the target skill relative to the release position, the damage range of the target skill is determined during the battle in the game, which can be understood as the damage range of the target skill is also determined based on the hexagonal scene map. Therefore, the damage range of the target skill matches the hexagonal scene map more accurately. Compared to calculating the damage range based on a conventional two-dimensional map and displaying it on a hexagonal scene map, this method can also improve the accuracy of displaying the damage range.

In some examples, the information acquisition module 92 is further configured to: determine second relative position information of the release position relative to an object position of a virtual object that releases the target skill; and acquire the first relative position information of the damage range of the target skill corresponding to the second relative position information, wherein, when the second relative position information is different, the first relative position information corresponding to the second relative position information is different.

In some examples, the information acquisition module 92 is further configured to: establish a first hexagonal coordinate system with a scene unit corresponding to the object position as origin, and determine coordinate information of the release position in the first hexagonal coordinate system as the second relative position information; wherein the second relative position information is configured to indicate a release direction and a release distance of the release of the target skill by the virtual object.

In some examples, the information acquisition module 92 is further configured to: establish a second hexagonal coordinate system with the scene unit corresponding to the release position as origin; set one or more target scene units belonging to the damage range of the target skill; and determine coordinate information of the one or more target scene units in the second hexagonal coordinate system as the first relative position information of the damage range of the target skill corresponding to the second relative position information.

In some examples, the information acquisition module is further configured to: set, based on a shape of the damage range of the target skill, the one or more target scene units belonging to the damage range of the target skill.

In some examples, the information acquisition module 92 is further configured to: in response to a line connecting the object position and the release position satisfying a specified condition, set the one or more target scene units to make a center line of an area corresponding to the one or more target scene units coincide with the line connecting the object position and the release position; in response to the line connecting the object position and the release position failing to satisfy the specified condition, set the one or more target scene units to minimize an angle between the center line of the area corresponding to the one or more target scene units and the line connecting the object position and the release position; wherein the specified condition includes: the line connecting the object position and the release position being perpendicular to any side of a hexagonal scene unit in the virtual scene, or the line connecting the object position and the release position passing through any corner of a hexagonal scene unit in the virtual scene.

In some examples, the damage range determination module 94 is further configured to: acquire coordinate information of the release position in a first hexagonal coordinate system, wherein the first hexagonal coordinate system is a coordinate system with a scene unit corresponding to an object position as origin; and determine coordinate information of the damage range of the target skill in the first hexagonal coordinate system based on the coordinate information of the release position in the first hexagonal coordinate system and the first relative position information of the damage range of the target skill.

The specific implementation details of each module in the apparatus for determining the damage range of the skill have been described in the corresponding method for determining the damage range of the skill, and are not repeated here.

Embodiments of the present disclosure also provide an electronic device including a processor and a memory, wherein the memory stores machine-executable instructions executable by the processor that, when executed by the processor, cause the processor to implement the method for determining the damage range of the skill as described above.

Referring to FIG. 10, the electronic device includes a processor 100 and a memory 101. The memory 101 stores machine-executable instructions that the processor 100 can execute to implement the method for determining the damage range of the skill as described above.

Furthermore, the electronic device shown in FIG. 10 also includes a bus 102 and a communication interface 103. The processor 100, communication interface 103, and memory 101 are connected via the bus 102.

The memory 101 may include Random Access Memory (RAM) and may also include non-volatile memory, such as at least one disk memory. Communication between this system element and at least one other element may be achieved via at least one communication interface 103 (which may be wired or wireless), utilizing the internet, wide area network, local area network, metropolitan area network, etc. The bus 102 can be an ISA bus, PCI bus, or EISA bus, among others. The bus may be divided into address bus, data bus, control bus, etc. For illustration purposes, only a two-way arrow is used in FIG. 10 to represent the bus, but this does not imply the presence of only one bus or one type of bus.

The processor 100 may be an integrated circuit chip with signal processing capabilities. In the implementation process, the steps of the above method can be completed through integrated logic circuits in the hardware of the processor 100 or in the form of software instructions. The processor 100 can be a general-purpose processor, including a Central Processing Unit (CPU), a Network Processor (NP), etc. It can also be a Digital Signal Processor (DSP), an Application Specific Integrated Circuit (ASIC), a Field-Programmable Gate Array (FPGA), or other programmable logic devices, discrete gates, or transistor logic devices, or discrete hardware components. It can implement or execute the methods, steps, and logic diagrams disclosed in the embodiments of the present disclosure. A general-purpose processor can be a microprocessor or any conventional processor. The steps of the method disclosed in the embodiments of the present disclosure can be directly embodied as being completed by a hardware decoding processor, or completed by a combination of hardware and software modules in the decoding processor. The software module can be located in mature storage media in the field such as random access memory, flash memory, read-only memory, programmable read-only memory, electrically erasable programmable read-only memory, or register. The storage medium is located in the memory 101, and the processor 100 reads the information in the memory 101, combining its hardware to complete the steps of the method for determining the damage range of the skill in the above-mentioned embodiments, such as: in response to release of a target skill, determining a release position of the target skill, wherein the release position is located in a scene unit within a virtual scene, the scene unit is hexagonal, and the virtual scene is composed of a plurality of scene units arranged consecutively; acquiring, based on the release position, first relative position information of a damage range of the target skill, wherein the first relative position information includes position information of the damage range of the target skill relative to the release position; and determining the damage range of the target skill based on the first relative position information of the damage range of the target skill.

In some examples, acquiring, based on the release position, the first relative position information of the damage range of the target skill includes: determining second relative position information of the release position relative to an object position of a virtual object that releases the target skill; and acquiring the first relative position information of the damage range of the target skill corresponding to the second relative position information, where, when the second relative position information is different, the first relative position information corresponding to the second relative position information is different.

In some examples, determining the second relative position information of the release position relative to the object position of the virtual object that releases the target skill includes: establishing a first hexagonal coordinate system with a scene unit corresponding to the object position as origin, and determining coordinate information of the release position in the first hexagonal coordinate system as the second relative position information; where the second relative position information is configured to indicate a release direction and a release distance of the release of the target skill by the virtual object.

In some examples, the first relative position information of the damage range of the target skill corresponding to the second relative position information is pre-set by: establishing a second hexagonal coordinate system with the scene unit corresponding to the release position as origin; setting one or more target scene units belonging to the damage range of the target skill; and determining coordinate information of the one or more target scene units in the second hexagonal coordinate system as the first relative position information of the damage range of the target skill corresponding to the second relative position information.

In some examples, setting the one or more target scene units belonging to the damage range of the target skill includes: setting, based on a shape of the damage range of the target skill, the one or more target scene units belonging to the damage range of the target skill.

In some examples, setting the one or more target scene units belonging to the damage range of the target skill includes: in response to a line connecting the object position and the release position satisfying a specified condition, setting the one or more target scene units to make a center line of an area corresponding to the one or more target scene units coincide with the line connecting the object position and the release position; in response to the line connecting the object position and the release position failing to satisfy the specified condition, setting the one or more target scene units to minimize an angle between the center line of the area corresponding to the one or more target scene units and the line connecting the object position and the release position; where the specified condition includes: the line connecting the object position and the release position being perpendicular to any side of a hexagonal scene unit in the virtual scene, or the line connecting the object position and the release position passing through any corner of a hexagonal scene unit in the virtual scene.

In some examples, determining the damage range of the target skill based on the first relative position information of the damage range of the target skill includes: acquiring coordinate information of the release position in a first hexagonal coordinate system, where the first hexagonal coordinate system is a coordinate system with a scene unit corresponding to an object position of a virtual object that releases the target skill, as origin; and determining coordinate information of the damage range of the target skill in the first hexagonal coordinate system based on the coordinate information of the release position in the first hexagonal coordinate system and the first relative position information of the damage range of the target skill.

Through the above embodiments, the relative position information of the damage range of the target skill relative to the release position can be pre-stored, and after the release position is determined during the battle in the game, the damage range of the target skill can be directly determined based on the relative position information, without the need to calculate whether each hexagon is within the damage range, reducing the computation and alleviating the computational pressure.

Furthermore, the pre-stored relative position information of the damage range of the target skill relative to the release position is determined based on the hexagonal scene map. Based on the pre-stored relative position information of the damage range of the target skill relative to the release position, the damage range of the target skill is determined during the battle in the game, which can be understood as the damage range of the target skill is also determined based on the hexagonal scene map. Therefore, the damage range of the target skill matches the hexagonal scene map more accurately. Compared to calculating the damage range based on a conventional two-dimensional map and displaying it on a hexagonal scene map, this method can also improve the accuracy of displaying the damage range.

Embodiments of the present disclosure further provide a machine-readable storage medium, which stores machine-executable instructions. When the machine-executable instructions are called or invoked by a processor, the machine-executable instructions cause the processor to implement the method of determining the damage range of the skill as described above, such as: in response to release of a target skill, determining a release position of the target skill, wherein the release position is located in a scene unit within a virtual scene, the scene unit is hexagonal, and the virtual scene is composed of a plurality of scene units arranged consecutively; acquiring, based on the release position, first relative position information of a damage range of the target skill, wherein the first relative position information includes position information of the damage range of the target skill relative to the release position; and determining the damage range of the target skill based on the first relative position information of the damage range of the target skill.

In some examples, acquiring, based on the release position, the first relative position information of the damage range of the target skill includes: determining second relative position information of the release position relative to an object position of a virtual object that releases the target skill; and acquiring the first relative position information of the damage range of the target skill corresponding to the second relative position information, where, when the second relative position information is different, the first relative position information corresponding to the second relative position information is different.

In some examples, determining the second relative position information of the release position relative to the object position of the virtual object that releases the target skill includes: establishing a first hexagonal coordinate system with a scene unit corresponding to the object position as origin, and determining coordinate information of the release position in the first hexagonal coordinate system as the second relative position information; where the second relative position information is configured to indicate a release direction and a release distance of the release of the target skill by the virtual object.

In some examples, the first relative position information of the damage range of the target skill corresponding to the second relative position information is pre-set by: establishing a second hexagonal coordinate system with the scene unit corresponding to the release position as origin; setting one or more target scene units belonging to the damage range of the target skill; and determining coordinate information of the one or more target scene units in the second hexagonal coordinate system as the first relative position information of the damage range of the target skill corresponding to the second relative position information.

In some examples, setting the one or more target scene units belonging to the damage range of the target skill includes: setting, based on a shape of the damage range of the target skill, the one or more target scene units belonging to the damage range of the target skill.

In some examples, setting the one or more target scene units belonging to the damage range of the target skill includes: in response to a line connecting the object position and the release position satisfying a specified condition, setting the one or more target scene units to make a center line of an area corresponding to the one or more target scene units coincide with the line connecting the object position and the release position; in response to the line connecting the object position and the release position failing to satisfy the specified condition, setting the one or more target scene units to minimize an angle between the center line of the area corresponding to the one or more target scene units and the line connecting the object position and the release position; where the specified condition includes: the line connecting the object position and the release position being perpendicular to any side of a hexagonal scene unit in the virtual scene, or the line connecting the object position and the release position passing through any corner of a hexagonal scene unit in the virtual scene.

In some examples, determining the damage range of the target skill based on the first relative position information of the damage range of the target skill includes: acquiring coordinate information of the release position in a first hexagonal coordinate system, where the first hexagonal coordinate system is a coordinate system with a scene unit corresponding to an object position of a virtual object that releases the target skill, as origin; and determining coordinate information of the damage range of the target skill in the first hexagonal coordinate system based on the coordinate information of the release position in the first hexagonal coordinate system and the first relative position information of the damage range of the target skill.

Through the above embodiments, the relative position information of the damage range of the target skill relative to the release position can be pre-stored, and after the release position is determined during the battle in the game, the damage range of the target skill can be directly determined based on the relative position information, without the need to calculate whether each hexagon is within the damage range, reducing the computation and alleviating the computational pressure.

Furthermore, the pre-stored relative position information of the damage range of the target skill relative to the release position is determined based on the hexagonal scene map. Based on the pre-stored relative position information of the damage range of the target skill relative to the release position, the damage range of the target skill is determined during the battle in the game, which can be understood as the damage range of the target skill is also determined based on the hexagonal scene map. Therefore, the damage range of the target skill matches the hexagonal scene map more accurately. Compared to calculating the damage range based on a conventional two-dimensional map and displaying it on a hexagonal scene map, this method can also improve the accuracy of displaying the damage range.

The computer program product of the method, device, and system for determining the damage range of the skill provided in the embodiments of the present disclosure includes a computer-readable storage medium storing program codes. The program codes include instructions that can be used to execute the method described in the preceding method embodiments. Specific implementations can be referred to in the method embodiments, and will not be repeated here.

It is clearly understood by those skilled in the art that, for the convenience and brevity of description, the specific working processes of the above-described systems and devices can refer to the corresponding processes in the aforementioned method embodiments, and will not be repeated here.

In addition, in the description of the embodiments of the present disclosure, unless otherwise explicitly defined and limited, the terms “install”, “connect”, and “link” should be broadly interpreted. For example, they can refer to fixed connections, detachable connections, or integral connections; they can be mechanical connections or electrical connections; they can be directly connected or indirectly connected through intermediate media; they can also refer to the internal communication between two elements. For those skilled in the art, the specific meanings of the above terms in the present disclosure can be understood according to specific situations.

If the functions described herein are implemented as software functional units and sold or used as independent products, they can be stored in a computer-readable storage medium. Based on such an understanding, the technical solution of the present disclosure, or the part that contributes to the prior art, or a part of the technical solution, can be embodied in the form of a software product. The computer software product is stored in a storage medium and includes several instructions for enabling a computer device (which can be a personal computer, a server, or a network device, etc.) to perform all or part of the steps of the method described in the various embodiments of the present disclosure. The aforementioned storage medium includes various media that can store program codes, such as USB flash drives, portable hard drives, Read-Only Memory (ROM), Random Access Memory (RAM), magnetic disks, or optical disks.

In the description of the present disclosure, it should be noted that terms such as “center,” “above,” “below;” “left,” “right,” “vertical,” “horizontal,” “inner,” “outer,” and the like indicating orientation or positional relationships are based on the orientation or positional relationships shown in the drawings, which are used for convenience of description of the present disclosure and simplification of the description. They do not indicate or imply that the device or component referred to must have specific orientation, constructed and operated in specific orientation. Therefore, they should not be understood as limiting the present disclosure. In addition, terms such as “first,” “second,” “third” are used for descriptive purposes only, and should not be construed as indicating or implying relative importance.

Finally, it should be noted that the above embodiments are merely specific implementations of the present disclosure, used to illustrate the technical solutions of the present disclosure, and are not intended to limit them. The scope of protection of the present disclosure is not limited to this. Although the present disclosure has been described in detail with reference to the preceding embodiments, those skilled in the art should understand that any technician familiar with the technical field can still modify or easily conceive variations to the technical solutions described in the preceding embodiments, or replace some of the technical features with equivalent ones, within the technical scope disclosed by the present disclosure. Such modifications, variations, or replacements do not make the essence of the corresponding technical solutions deviate from the spirit and scope of the technical solutions of the embodiments of the present disclosure and should all be covered within the scope of protection of the present disclosure. Therefore, the scope of protection of the present disclosure should be based on the scope of protection of the claims.

1. A method for determining a damage range of a skill, comprising:
in response to release of a target skill, determining a release position of the target skill, wherein the release position is located in a scene unit within a virtual scene, the scene unit is hexagonal, and the virtual scene comprises a plurality of scene units arranged consecutively;
acquiring, based on the release position, a first relative position of a damage range of the target skill, wherein the first relative position comprises position information of the damage range of the target skill relative to the release position; and
determining the damage range of the target skill based on the first relative position of the damage range of the target skill.

2. The method of claim 1, wherein acquiring the first relative position of the damage range of the target skill comprises:
determining a second relative position of the release position relative to an object position of a virtual object that releases the target skill; and
acquiring the first relative position of the damage range of the target skill corresponding to the second relative position, wherein the first relative position corresponding to the second relative position varies in accordance with the second relative position.

3. The method of claim 2, wherein determining the second relative position of the release position relative to the object position of the virtual object that releases the target skill, comprises:
establishing a first hexagonal coordinate system with a scene unit corresponding to the object position as origin, and determining coordinate information of the release position in the first hexagonal coordinate system as the second relative position; wherein the second relative position is configured to indicate a release direction and a release distance of the release of the target skill by the virtual object.

4. The method of claim 2, wherein the first relative position of the damage range of the target skill corresponding to the second relative position is pre-set by:
establishing a second hexagonal coordinate system with the scene unit corresponding to the release position as origin;
setting one or more target scene units belonging to the damage range of the target skill; and
determining coordinate information of the one or more target scene units in the second hexagonal coordinate system as the first relative position of the damage range of the target skill corresponding to the second relative position.

5. The method of claim 4, wherein setting the one or more target scene units belonging to the damage range of the target skill comprises:
setting, based on a shape of the damage range of the target skill, the one or more target scene units belonging to the damage range of the target skill.

6. The method of claim 4, wherein setting the one or more target scene units belonging to the damage range of the target skill comprises:
in response to a line connecting the object position and the release position satisfying a specified condition, setting the one or more target scene units to make a center line of an area corresponding to the one or more target scene units coincide with the line connecting the object position and the release position;
in response to the line connecting the object position and the release position failing to satisfy the specified condition, setting the one or more target scene units to minimize an angle between the center line of the area corresponding to the one or more target scene units and the line connecting the object position and the release position;
wherein the specified condition comprises: the line connecting the object position and the release position being perpendicular to any side of a hexagonal scene unit in the virtual scene, or the line connecting the object position and the release position passing through any corner of a hexagonal scene unit in the virtual scene.

7. The method of claim 1, wherein determining the damage range of the target skill based on the first relative position of the damage range of the target skill, comprises:
acquiring coordinate information of the release position in a first hexagonal coordinate system, wherein the first hexagonal coordinate system is a coordinate system with a scene unit corresponding to an object position of a virtual object that releases the target skill, as origin; and
determining coordinate information of the damage range of the target skill in the first hexagonal coordinate system based on the coordinate information of the release position in the first hexagonal coordinate system and the first relative position-information of the damage range of the target skill.

8. (canceled)

9. An electronic device comprising a processor and a memory, wherein the memory stores machine instructions executable by the processor that, when executed by the processor, cause the processor to perform following acts:
in response to release of a target skill, determining a release position of the target skill, wherein the release position is located in a scene unit within a virtual scene, the scene unit is hexagonal, and the virtual scene comprises a plurality of scene units arranged consecutively;
acquiring, based on the release position, a first relative position of a damage range of the target skill, wherein the first relative position comprises position information of the damage range of the target skill relative to the release position; and
determining the damage range of the target skill based on the first relative position of the damage range of the target skill.

10. A non-transitory computer-readable storage medium storing instructions, wherein the instructions, when invoked and executed by a processor, cause the processor to perform following acts:
in response to release of a target skill, determining a release position of the target skill, wherein the release position is located in a scene unit within a virtual scene, the scene unit is hexagonal, and the virtual scene comprises a plurality of scene units arranged consecutively;
acquiring, based on the release position, a first relative position of a damage range of the target skill, wherein the first relative position comprises position information of the damage range of the target skill relative to the release position; and
determining the damage range of the target skill based on the first relative position of the damage range of the target skill.

11. The method of claim 4, further comprising: presetting a damage shape and a damage distance of the damage range of the target skill; wherein setting one or more target scene units belonging to the damage range of the target skill comprises:
setting the one or more target scene units to make an outline of a shape formed by the one or more target scene units match the damage shape and the damage distance.

12. The electronic device of claim 9, wherein the processor is further configured to:
determine a second relative position of the release position relative to an object position of a virtual object that releases the target skill; and
acquire the first relative position of the damage range of the target skill corresponding to the second relative position, wherein the first relative position corresponding to the second relative position varies in accordance with the second relative position.

13. The electronic device of claim 12, wherein the processor is further configured to:
establish a first hexagonal coordinate system with a scene unit corresponding to the object position as origin, and determine coordinate information of the release position in the first hexagonal coordinate system as the second relative position; wherein the second relative position is configured to indicate a release direction and a release distance of the release of the target skill by the virtual object.

14. The electronic device of claim 12, wherein the processor is further configured to:
establish a second hexagonal coordinate system with the scene unit corresponding to the release position as origin;
set one or more target scene units belonging to the damage range of the target skill; and
determine coordinate information of the one or more target scene units in the second hexagonal coordinate system as the first relative position of the damage range of the target skill corresponding to the second relative position.

15. The electronic device of claim 14, wherein the processor is further configured to:
set, based on a shape of the damage range of the target skill, the one or more target scene units belonging to the damage range of the target skill.

16. The electronic device of claim 14, wherein the processor is further configured to:
preset a damage shape and a damage distance of the damage range of the target skill; and
set the one or more target scene units to make an outline of a shape formed by the one or more target scene units match the damage shape and the damage distance.

17. The electronic device of claim 14, wherein the processor is further configured to:
in response to a line connecting the object position and the release position satisfying a specified condition, set the one or more target scene units to make a center line of an area corresponding to the one or more target scene units coincide with the line connecting the object position and the release position;
in response to the line connecting the object position and the release position failing to satisfy the specified condition, set the one or more target scene units to minimize an angle between the center line of the area corresponding to the one or more target scene units and the line connecting the object position and the release position;
wherein the specified condition comprises: the line connecting the object position and the release position being perpendicular to any side of a hexagonal scene unit in the virtual scene, or the line connecting the object position and the release position passing through any corner of a hexagonal scene unit in the virtual scene.

18. The electronic device of claim 9, wherein the processor is further configured to:
acquire coordinate information of the release position in a first hexagonal coordinate system, wherein the first hexagonal coordinate system is a coordinate system with a scene unit corresponding to an object position of a virtual object that releases the target skill, as origin; and
determine coordinate information of the damage range of the target skill in the first hexagonal coordinate system based on the coordinate information of the release position in the first hexagonal coordinate system and the first relative position of the damage range of the target skill.

19. A non-transitory computer-readable storage medium storing instructions, wherein the instructions, when invoked and executed by a processor, cause the processor to perform the method for determining the damage range of the skill according to claim 2.

20. A non-transitory computer-readable storage medium storing instructions, wherein the instructions, when invoked and executed by a processor, cause the processor to perform the method for determining the damage range of the skill according to claim 3.

21. A non-transitory computer-readable storage medium storing instructions, wherein the instructions, when invoked and executed by a processor, cause the processor to perform the method for determining the damage range of the skill according to claim 4.
